(19) United States
(12) Patent Application Publication
(10) Pub. No.: US 2026/0167494 A1
(43) Pub. Date: Jun. 18, 2026

(54) METHODS AND SYSTEMS FOR PRODUCING CARBONACEOUS MATERIAL FROM COAL

(71) Applicant: West Virginia University Board of Governors on Behalf of West Virginia University, Morgantown, WV (US)

(72) Inventors: Yuxin Wang, Morgantown, WV (US); Jianli Hu, Morgantown, WV (US); Xingbo Liu, Morgantown, WV (US); Chunlin Luo, Morgantown, WV (US)

(21) Appl. No.: 19/421,551

(22) Filed: Dec. 16, 2025

Related U.S. Application Data
(60) Provisional application No. 63/734,320, filed on Dec. 16, 2024.

(51) Int. Cl. C01B 32/05; H01M 10/0525; H01M 10/054

(52) U.S. Cl. CPC C01B 32/05; H01M 10/0525; H01M 10/054; C01P 2002/82; C01P 2006/12; C01P 2006/14; C01P 2006/40

(57) ABSTRACT

In accordance with the purpose(s) of the present disclosure, as embodied and broadly described herein, the disclosure, in one aspect, relates to methods for producing carbonaceous material from coal. In one aspect, the methods comprise providing a coal material; and heating the coal material by microwave irradiation or microwave plasma to a target temperature of about 500° C. to about 1200° C., thereby producing a carbonaceous product. In another aspect, disclosed herein are batteries comprising a carbonaceous material produced using the disclosed methods. This abstract is intended as a scanning tool for purposes of searching in the particular art and is not intended to be limiting of the present disclosure.

### CROSS-REFERENCE TO RELATED APPLICATIONS

This application claims the benefit of and priority to U.S. Provisional Application No. 63/734,320, filed on Dec. 16, 2024 which is incorporated herein by reference in its entirety.

### BACKGROUND

Conventional thermal pyrolysis is a simple and widely used method for converting coal to hard carbon. However, this energy-intensive process involves high temperatures, e.g., >1100° C., and a long reaction time, lasting at least a few hours. The conventional thermal pyrolysis of coal also results in lower yields and product quality due to secondary cracking reactions, such as low surface area. Additionally, coal thermal pyrolysis faces challenges in the process, including the plugging of reactor lines due to the accumulation of heavy tars resulting from side reactions. Despite advances in technologies for converting coal to carbonaceous materials such as hard carbon, there is a need for coal conversion methods and systems that are more efficient and less costly. These needs and other needs are satisfied by the present disclosure.

### SUMMARY

In accordance with the purpose(s) of the present disclosure, as embodied and broadly described herein, the disclosure, in one aspect, relates to methods for producing carbonaceous material from coal. In one aspect, the methods comprise providing a coal material; and heating the coal material by microwave irradiation or microwave plasma to a target temperature of about 500° C. to about 1200° C., thereby producing a carbonaceous product. The disclosure also relates to batteries comprising a carbonaceous material produced by the disclosed methods.

Other systems, methods, features, and advantages of the present disclosure will be or become apparent to one with skill in the art upon examination of the following drawings and detailed description. It is intended that all such additional systems, methods, features, and advantages be included within this description, be within the scope of the present disclosure, and be protected by the accompanying claims. In addition, all optional and preferred features and modifications of the described embodiments are usable in all aspects of the disclosure taught herein. Furthermore, the individual features of the dependent claims, as well as all optional and preferred features and modifications of the described embodiments are combinable and interchangeable with one another.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views.

FIG. 1 shows a representative schematic diagram of a microwave reactor. M1 and M2 represent motors for sample delivery.

FIG. 2A shows images depicting various views of a representative semi-automated pouch cell assembly line.

FIG. 2B shows a plot of capacity and coulombic efficiency vs cycle number for a representative fabricated ˜1 Ah HC/NaMNC pouch cell, with an inset image depicting the pouch cell.

FIG. 3 shows a representative plot of quantity of gas (N₂) adsorbed vs the relative pressure for carbonaceous material produced from coal using various methods.

FIG. 4 shows representative Raman spectra of carbonaceous material produced from coal using various methods.

FIG. 5 shows images depicting various views of a microwave reactor.

FIG. 6 shows a representative diagram depicting the changes in ordering of a carbon material with heat treatment.

FIG. 7 shows an image depicting a reactor and representative temperature plots of a reaction chamber heated using microwave heating vs conductive heating.

Additional advantages of the invention will be set forth in part in the description which follows, and in part will be obvious from the description, or can be learned by practice of the invention. The advantages of the invention will be realized and attained by means of the elements and combinations particularly pointed out in the appended claims. It is to be understood that both the foregoing general description and the following detailed description are exemplary and explanatory only and are not restrictive of the invention, as claimed.

### DETAILED DESCRIPTION

Many modifications and other embodiments disclosed herein will come to mind to one skilled in the art to which the disclosed compositions and methods pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. The skilled artisan will recognize many variants and adaptations of the aspects described herein. These variants and adaptations are intended to be included in the teachings of this disclosure and to be encompassed by the claims herein.

Although specific terms are employed herein, they are used in a generic and descriptive sense only and not for purposes of limitation.

As will be apparent to those of skill in the art upon reading this disclosure, each of the individual embodiments described and illustrated herein has discrete components and features which may be readily separated from or combined with the features of any of the other several embodiments without departing from the scope or spirit of the present disclosure.

Any recited method can be carried out in the order of events recited or in any other order that is logically possible. That is, unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is no way intended that an order be inferred, in any respect. This holds for any possible non-express basis for interpretation, including matters of logic with respect to arrangement of steps or operational flow, plain meaning derived from grammatical organization or punctuation, or the number or type of aspects described in the specification.

All publications mentioned herein are incorporated herein by reference to disclose and describe the methods and/or materials in connection with which the publications are cited. The publications discussed herein are provided solely for their disclosure prior to the filing date of the present application. Nothing herein is to be construed as an admission that the present invention is not entitled to antedate such publication by virtue of prior invention. Further, the dates of publication provided herein can be different from the actual publication dates, which can require independent confirmation.

While aspects of the present disclosure can be described and claimed in a particular statutory class, such as the system statutory class, this is for convenience only and one of skill in the art will understand that each aspect of the present disclosure can be described and claimed in any statutory class.

It is also to be understood that the terminology used herein is for the purpose of describing particular aspects only and is not intended to be limiting. Unless defined otherwise, all technical and scientific terms used herein have the same meaning as commonly understood by one of ordinary skill in the art to which the disclosed compositions and methods belong. It will be further understood that terms, such as those defined in commonly used dictionaries, should be interpreted as having a meaning that is consistent with their meaning in the context of the specification and relevant art and should not be interpreted in an idealized or overly formal sense unless expressly defined herein.

Prior to describing the various aspects of the present disclosure, the following definitions are provided and should be used unless otherwise indicated. Additional terms may be defined elsewhere in the present disclosure.

### A. Definitions

As used herein, “comprising” is to be interpreted as specifying the presence of the stated features, integers, steps, or components as referred to, but does not preclude the presence or addition of one or more features, integers, steps, or components, or groups thereof. Moreover, each of the terms “by”, “comprising,” “comprises”, “comprised of,” “including,” “includes,” “included,” “involving,” “involves,” “involved,” and “such as” are used in their open, non-limiting sense and may be used interchangeably. Further, the term “comprising” is intended to include examples and aspects encompassed by the terms “consisting essentially of” and “consisting of.” Similarly, the term “consisting essentially of” is intended to include examples encompassed by the term “consisting of.

As used in the specification and the appended claims, the singular forms “a,” “an” and “the” include plural referents unless the context clearly dictates otherwise. Thus, for example, reference to “a product” or “a reactant” includes, but is not limited to, two or more such products, reactants, and the like.

It should be noted that ratios, concentrations, amounts, and other numerical data can be expressed herein in a range format. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. Ranges can be expressed herein as from “about” one particular value, and/or to “about” another particular value. Similarly, when values are expressed as approximations, by use of the antecedent “about,” it will be understood that the particular value forms a further aspect. For example, if the value “about 10” is disclosed, then “10” is also disclosed.

When a range is expressed, a further aspect includes from the one particular value and/or to the other particular value. For example, where the stated range includes one or both of the limits, ranges excluding either or both of those included limits are also included in the disclosure, e.g. the phrase “x to y” includes the range from ‘x’ to ‘y’ as well as the range greater than ‘x’ and less than ‘y’. The range can also be expressed as an upper limit, e.g. ‘about x, y, z, or less’ and should be interpreted to include the specific ranges of ‘about x’, ‘about y’, and ‘about z’ as well as the ranges of ‘less than x’, less than y′, and ‘less than z’. Likewise, the phrase ‘about x, y, z, or greater’ should be interpreted to include the specific ranges of ‘about x’, ‘about y’, and ‘about z’ as well as the ranges of ‘greater than x’, greater than y′, and ‘greater than z’. In addition, the phrase “about ‘x’ to ‘y’”, where ‘x’ and ‘y’ are numerical values, includes “about ‘x’ to about ‘y’”.

It is to be understood that such a range format is used for convenience and brevity, and thus, should be interpreted in a flexible manner to include not only the numerical values explicitly recited as the limits of the range, but also to include all the individual numerical values or sub-ranges encompassed within that range as if each numerical value and sub-range is explicitly recited. To illustrate, a numerical range of “about 0.1% to 5%” should be interpreted to include not only the explicitly recited values of about 0.1% to about 5%, but also include individual values (e.g., about 1%, about 2%, about 3%, and about 4%) and the sub-ranges (e.g., about 0.5% to about 1.1%; about 5% to about 2.4%; about 0.5% to about 3.2%, and about 0.5% to about 4.4%, and other possible sub-ranges) within the indicated range.

As used herein, the terms “about,” “approximate,” “at or about,” and “substantially” mean that the amount or value in question can be the exact value or a value that provides equivalent results or effects as recited in the claims or taught herein. That is, it is understood that amounts, sizes, formulations, parameters, and other quantities and characteristics are not and need not be exact but may be approximate and/or larger or smaller, as desired, reflecting tolerances, conversion factors, rounding off, measurement error and the like, and other factors known to those of skill in the art such that equivalent results or effects are obtained. In some circumstances, the value that provides equivalent results or effects cannot be reasonably determined. In such cases, it is generally understood, as used herein, that “about” and “at or about” mean the nominal value indicated ±10% variation unless otherwise indicated or inferred. In general, an amount, size, formulation, parameter or other quantity or characteristic is “about,” “approximate,” or “at or about” whether or not expressly stated to be such. It is understood that where “about,” “approximate,” or “at or about” is used before a quantitative value, the parameter also includes the specific quantitative value itself, unless specifically stated otherwise.

As used herein, the terms “optional” or “optionally” means that the subsequently described event or circumstance can or cannot occur, and that the description includes instances where said event or circumstance occurs and instances where it does not.

The term “contacting” as used herein refers to bringing a disclosed analyte, compound, chemical, or material in proximity to another disclosed analyte, compound, chemical, or material as indicated by the context.

Unless otherwise specified, pressures referred to herein are based on atmospheric pressure (i.e., one atmosphere).

### B. Discussion

The production of carbonaceous materials such as hard carbon or graphite from coal through conventional thermal pyrolysis presents significant challenges due to its high energy demands, requiring temperatures exceeding, for example, 1100° C. and extended reaction times on the order of, for example, a few hours. This method is not only energy-intensive but can also result in lower carbon yields and product quality. Additionally, the conventional process is plagued by operational issues such as reactor line plugging caused by heavy tar accumulation. These limitations highlight the need for more efficient and effective methods to produce high-quality carbonaceous materials, which is used for applications such as sodium-ion battery anodes. Existing approaches struggle to balance energy efficiency with the quality of the carbon produced, necessitating solutions to overcome these hurdles.

Disclosed herein is a method for the production of a carbonaceous material (e.g., a carbonaceous product) from coal. As used herein, a carbonaceous material or product refers to a material or product that comprises carbon, such as hard carbon, soft carbon, graphitic carbon, or a combination thereof. This method utilizes relatively rapid microwave heating to achieve pyrolysis of a coal material at relatively temperatures compared to standard thermal treatments.

The approach can reduce the energy consumption required for coal treatment and/or enhance the quality of the carbonaceous material produced. In one aspect, the quality of the material has an improved porous structure and increased surface area compared to a material produced using conventional thermal treatment methods. The disclosed methods can allow for relatively fast, relatively selective, and volumetric heating with precision control, leading to higher energy efficiency, reduced power requirements, and/or minimized reactor maintenance issues. This method can provide a relatively sustainable (e.g., lower cost) and efficient pathway for converting coal into a high-quality carbonaceous product, with potential applications in energy storage technologies such as sodium-ion and/or lithium-ion batteries.

In one aspect, the disclosed method comprises providing a coal material and heating the coal material by microwave irradiation or microwave plasma to a target temperature of about 500° C. to about 1200° C., thereby producing a carbonaceous product. The disclosed methods can be carried out in an inert atmosphere (e.g., under argon). The coal material can include various types (e.g., ranks) of coal, including anthracite, bituminous coal, subbituminous coal, lignite, or any combination thereof. The coal can be extracted (e.g., via mining) from one or more regions. In one aspect, the coal material can be pre-treated prior to undergoing the disclosed microwave treatment methods. This pre-treatment can include cleaning the coal, such as de-ashing. In one aspect, the coal material (naturally or after undergoing pre-treatment) comprises from about 1 weight % (wt %) to about 15 wt %, about 1 wt % to about 10 wt %, about 1 wt % to about 5 wt %, about 5 wt % to about 15 wt %, or about 5 wt % to about 10 wt % ash. Ash can include, but is not limited to, non-combustible components such as metals (e.g., aluminum and iron), silicon, calcium, potassium, compounds thereof, or any combination thereof. In one aspect, the disclosed methods can produce a carbonaceous product from a coal material with a carbon yield of about 60% to about 100%, about 60% to about 90%, about 60% to about 80%, about 70% to about 100%, about 70% to about 90%, about 70% to about 80%, about 80% to about 100%, about 80% to about 90%, or about 90% to about 100%.

In another aspect, the target temperature can be from about 500° C. to about 1200° C., about 500° C. to about 1100° C., about 500° C. to about 1000° C., about 500° C. to about 900° C., about 500° C. to about 800° C., about 600° C. to about 1200° C., about 600° C. to about 1100° C., about 600° C. to about 1000° C., about 600° C. to about 900° C., or about 600° C. to about 800° C. In one aspect, the coal material can be heated at a rate of at least about 0.5° C./min until reaching the target temperature. In another aspect, the coal material can be heated at a rate of about 0.5° C./min to about 50° C./min, about 0.5° C./min to about 40° C./min, about 0.5° C./min to about 30° C./min, about 0.5° C./min to about 20° C./min, about 0.5° C./min to about 10° C./min, about 10° C./min to about 50° C./min, about 20° C./min to about 50° C./min, about 30° C./min to about 50° C./min, about 40° C./min to about 50° C./min, about 10° C./min to about 40° C./min, about 10° C./min to about 30° C./min, or about 30° C./min to about 50° C./min until reaching the target temperature. In one aspect, heating the coal material can further comprise holding the coal material at the target temperature for less than about 6 hours, less than about 5 hours, less than about 4 hours, less than about 3 hours, less than about 2 hours, or less than about 1 hour. In another aspect, heating the coal material can further comprise holding the coal material at the target temperature for about 30 minutes to about 6 hours, about 30 minutes to about 5 hours, about 30 minutes to about 4 hours, about 30 minutes to about 3 hours, about 30 minutes to about 2 hours, or about 30 minutes to about 1 hour. In one aspect, the coal material can exhibit an activation time of about 10 minutes to about 90 minutes, about 10 minutes to about 70 minutes, about 10 minutes to about 50 minutes, about 10 minutes to about 30 minutes, about 30 minutes to about 90 minutes, about 50 minutes to about 90 minutes, about 70 minutes to about 90 minutes, about 20 minutes to about 80 minutes, or about 30 minutes to about 70 minutes. Activation time, as used herein, can refer to the time it takes for the coal to convert to a carbonaceous material, though treatment of the material can continue past the activation time. In one aspect, the microwave treatment process pyrolyzes the coal to produce the carbonaceous product. For example, the microwave treatment can be set at a rate of about 10° C./min until reaching about 800° C. and then maintained for about 30 minutes. In contrast, a thermal pyrolysis process can include a 1° C./min ramping rate to 1300° C. and holding for 2 hours.

The microwave heating can be carried out by heating a reaction chamber containing the coal material using microwave irradiation or microwave plasma. The conditions under which microwave radiation is applied (e.g., period of time, frequency, and power) can be adjusted. For example, the reaction chamber can be heated using microwave irradiation with an output power of about 0.1 KW to about 1 KW, about 0.1 KW to about 0.8 KW, about 0.1 KW to about 0.6 KW, about 0.1 KW to about 0.4 KW, about 0.3 KW to about 1 KW, about 0.5 kW to about 1 KW, or about 0.7 KW to about 1 KW at 2.45 GHz for a period of time long enough for the desired carbonaceous material to be produced (e.g., from about 30 minutes to about 6 hours).

In one aspect, the microwave reaction chamber can be one component of a microwave reactor. The microwave reactor can be configured to continuously produce a carbonaceous product. For example, a feeding apparatus (e.g., an auger feeder or screw feeder) can continuously feed a coal feedstock material into the reaction chamber. The feeding apparatus can, optionally, be configured to grind or otherwise break down the coal feedstock into smaller particles. The feeding apparatus can also be in fluid communication with one or more gas chambers that allow an inert gas to flow into and fill at least the feeding apparatus, the reaction chamber, and/or other components of the reactor. In one aspect, the reaction chamber can include a barrel or tube for containing the coal material being fed into it by the feeding apparatus. The reaction chamber can, optionally, further include a component for moving the coal material through the reaction chamber before, during, and/or after treatment, such as a rotating screw. A microwave component can be in communication with the reaction chamber in order to generate and supply the microwave radiation to the reaction chamber. The source of microwave radiation can be, for example, a solid-state microwave generator. In one aspect, the microwave radiation can be used to sustain an ionized gas (a plasma, formed in a gas such as Ar) in the reaction chamber. The plasma can be in contact with the coal material. The reaction chamber can feed into a collector configured to collect the carbonaceous material. In one aspect, the microwave heating can be powered by renewable energy sources.

The carbonaceous product can comprise hard carbon, soft carbon, graphitic carbon, or a combination thereof. Hard carbon is a more disordered form of carbon, compared to graphite, that is difficult to graphitize or non-graphitizable at high temperatures (e.g., temperatures over 2500° C.). In one aspect, hard carbon can be characterized by an average interplanar spacing (the distance between adjacent planes of carbon) of about 0.37 nm to about 0.40 nm. Soft carbon has a structure that is less disordered than hard carbon but more disordered than graphite and is graphitizable at high temperatures (e.g., temperatures over 2500° C.). In one aspect, soft carbon can be characterized by an average interplanar spacing of about 0.34 nm to about 0.35 nm. Graphitic carbon or graphite is a relatively highly ordered form of carbon. In one aspect, graphite can be characterized by an average interplanar spacing of about 0.33 nm.

The carbonaceous product can be characterized using various metrics, such as surface area and pore volume. In one aspect, the carbonaceous product can have a Brunauer-Emmett-Teller (BET) surface area of about 5 m²/g to about 100 m²/g, about 5 m²/g to about 90 m²/g, about 5 m²/g to about 80 m²/g, about 5 m²/g to about 70 m²/g, about 5 m²/g to about 60 m²/g, about 5 m²/g to about 50 m²/g, about 5 m²/g to about 40 m²/g, about 5 m²/g to about 30 m²/g, about 15 m²/g to about 100 m²/g, about 15 m²/g to about 90 m²/g, about 15 m²/g to about 80 m²/g, about 15 m²/g to about 70 m²/g, about 15 m²/g to about 60 m²/g, about 15 m²/g to about 50 m²/g, about 15 m²/g to about 40 m²/g, about 25 m²/g to about 100 m²/g, about 25 m²/g to about 90 m²/g, about 25 m²/g to about 80 m²/g, about 25 m²/g to about 70 m²/g, about 25 m²/g to about 60 m²/g, about 25 m²/g to about 50 m²/g, about 35 m²/g to about 100 m²/g, about 35 m²/g to about 90 m²/g, about 35 m²/g to about 80 m²/g, about 35 m²/g to about 70 m²/g, about 35 m²/g to about 60 m²/g, about 35 m²/g to about 50 m²/g, about 45 m²/g to about 100 m²/g, about 45 m²/g to about 90 m²/g, about 45 m²/g to about 80 m²/g, about 45 m²/g to about 70 m²/g, or 45 m²/g to about 60 m²/g. The BET surface area can be measured using an inert gas such as nitrogen and refers to the total surface area of a material, inclusive of micropores.

In another aspect, the carbonaceous product can have a micropore surface area of about 5 m²/g to about 90 m²/g, about 5 m²/g to about 80 m²/g, about 5 m²/g to about 70 m²/g, about 5 m²/g to about 60 m²/g, about 5 m²/g to about 50 m²/g, about 5 m²/g to about 40 m²/g, about 5 m²/g to about 30 m²/g, about 15 m²/g to about 90 m²/g, about 15 m²/g to about 80 m²/g, about 15 m²/g to about 70 m²/g, about 15 m²/g to about 60 m²/g, about 15 m²/g to about 50 m²/g, about 15 m²/g to about 40 m²/g, about 25 m²/g to about 90 m²/g, about 25 m²/g to about 80 m²/g, about 25 m²/g to about 70 m²/g, about 25 m²/g to about 60 m²/g, about 25 m²/g to about 50 m²/g, about 25 m²/g to about 40 m²/g, about 35 m²/g to about 90 m²/g, about 35 m²/g to about 80 m²/g, about 35 m²/g to about 70 m²/g, about 35 m²/g to about 60 m²/g, or about 35 m²/g to about 50 m²/g. The micropore surface area can be measured directly or indirectly (e.g., calculated based on external surface area and BET surface area) using an inert gas such as nitrogen and refers to the total surface area of micropores in a material. In another aspect, the total surface area of the carbonaceous product (e.g., the BET surface area, including external surface area and any pore surface area) can be from about 60% to about 95%, about 65% to about 95%, about 70% to about 95%, about 75% to about 95%, about 80% to about 95%, or about 85% to about 95% micropore surface area.

A micropore is used herein to refer to a pore that has a width of less than about 0.2 nm or less than 0.2 nm (e.g., a pore size of about 0.1 nm to about 2 nm, about 0.5 nm to about 2 nm, about 1 nm to about 2 nm, about 0.1 nm to 2 nm, about 0.5 nm to 2 nm, or about 1 nm to 2 nm). A mesopore is used herein to refer to a pore that has a width of about 2 nm to about 50 nm or 2 nm to about 50 nm. In one aspect, the carbonaceous product can have a micropore volume of about 0.005 cm³/g to about 0.1 cm³/g, about 0.01 cm³/g to about 0.1 cm³/g, about 0.05 cm³/g to about 0.1 cm³/g, about 0.005 cm³/g to about 0.05 cm³/g, about 0.005 cm³/g to about 0.01 cm³/g, or about 0.01 cm³/g to about 0.05 cm³/g. In another aspect, the carbonaceous product can have a mesopore volume of about 0.001 cm³/g to about 0.01 cm³/g, about 0.001 cm³/g to about 0.005 cm³/g, or about 0.005 cm³/g to about 0.01 cm³/g.

Raman spectroscopy can be used to characterize the microstructure of a carbonaceous material. to the G-band peak intensity (IG, located around 1582 cm⁻¹). The defect density of the material can be characterized via the ratio of the D-band peak intensity (Ip, typically located around 1350 cm⁻¹) to the G-band peak intensity (IG, typically located around 1582 cm⁻¹) (Ip/IG). In one aspect, the carbonaceous product can have an Ip/IG ratio of from about 1.1 to about 1.5, about 1.1 to about 1.4, about 1.1 to about 1.3, about 1.1. to about 1.2, about 1.2 to about 1.5, about 1.2 to about 1.4, about 1.2 to about 1.3, about 1.3 to about 1.5, about 1.3 to about 1.4, 1.1 to about 1.5, 1.1 to about 1.4, 1.1 to about 1.3, 1.1. to about 1.2, 1.2 to about 1.5, 1.2 to about 1.4, 1.2 to about 1.3, 1.3 to about 1.5, or 1.3 to about 1.4.

In one aspect, also disclosed herein are batteries comprising the carbonaceous materials produced by the disclosed methods. In a further aspect, the anode of the battery can comprise the carbonaceous material. The battery can include, for example, a Li-ion battery or a Na-ion battery. In one aspect, when the battery is a Li-ion battery, the anode can comprise the carbonaceous material where the carbonaceous material comprises graphitic carbon. In another aspect, when the battery is a Na-ion battery, the anode can comprise the carbonaceous material where the carbonaceous material comprises hard carbon or soft carbon. In one aspect, the batteries can include pouch cell batteries.

In another aspect, the carbonaceous product can be characterized using various metrics associated with its use in a battery, such as sodiation capacity and coulombic efficiency. In one aspect, the carbonaceous product can have an initial sodiation capacity of about 200 mAH/g to about 500 mAH/g, about 200 mAH/g to about 450 mAH/g, about 200 mAH/g to about 400 mAH/g, about 200 mAH/g to about 350 mAH/g, about 200 mAH/g to about 300 mAH/g, about 250 mAH/g to about 500 mAH/g, about 250 mAH/g to about 450 mAH/g, about 250 mAH/g to about 400 mAH/g, about 250 mAH/g to about 350 mAH/g, or about 250 mAH/g to about 300 mAH/g. In another aspect, the carbonaceous product can have an initial coulombic efficiency of about 70% to about 100%, about 70% to about 90%, about 70% to about 80%, about 80% to about 100%, about 80% to about 90%, or about 90% to about 100%.

### C. Aspects

The following listing of exemplary aspects supports and is supported by the disclosure provided herein.

Aspect 1. A method comprising: providing a coal material; and heating the coal material by microwave irradiation or microwave plasma to a target temperature of about 500° C. to about 1200° C., thereby producing a carbonaceous product.

Aspect 2. The method of aspect 1 or aspect 2, wherein the target temperature is about 500° C. to about 1000° C.

Aspect 3. The method of any one of aspects 1-3, wherein the coal material is heated at a rate of at least about 0.5° C./min until reaching the target temperature.

Aspect 4. The method of any one of aspects 1-3, wherein the coal material is heated at a rate of about 0.5° C./min to about 50° C./min until reaching the target temperature.

Aspect 5. The method of any one of aspects 1-5, wherein heating the coal material further comprises holding the coal material at the target temperature for less than about 6 hours.

Aspect 6. The method of any one of aspects 1-5, wherein heating the coal material further comprises holding the coal material at the target temperature for about 30 minutes to about 6 hours.

Aspect 7. The method of any one of aspects 1-6, wherein the coal material comprises from about 1 wt % to about 15 wt % ash.

Aspect 8. The method of any one of aspects 1-7, wherein the coal material comprises anthracite, bituminous coal, subbituminous coal, lignite, or a combination thereof.

Aspect 9. The method of any one of aspects 1-5, wherein the coal material exhibits an activation time of about 10 minutes to about 90 minutes.

Aspect 10. The method of any one of aspects 1-9, wherein the carbonaceous product comprises hard carbon, soft carbon, graphitic carbon, or a combination thereof.

Aspect 11. The method of any one of aspects 1-10, wherein the carbonaceous product has a Brunauer-Emmett-Teller (BET) surface area of about 5 m²/g to about 100 m²/g.

Aspect 12. The method of any one of aspects 1-11, wherein the carbonaceous product has a micropore surface area of about 5 m²/g to about 90 m²/g.

Aspect 13. The method of any one of aspects 1-12, wherein the carbonaceous product has a micropore volume of about 0.005 cm³/g to about 0.1 cm³/g.

Aspect 14. The method of any one of aspects 1-13, wherein the carbonaceous product has an Ip/IG ratio of from about 1.1 to about 1.5, as determined by Raman spectroscopy.

Aspect 15. The method of any one of aspects 1-13, wherein the carbonaceous product has an Ip/IG ratio of from 1.1 to about 1.5, as determined by Raman spectroscopy.

Aspect 16. The method of any one of aspects 1-15, wherein the carbonaceous product has an initial sodiation capacity of about 200 mAh/g to about 500 mAh/g.

Aspect 17. The method of any one of aspects 1-16, wherein the carbonaceous product has an initial coulombic efficiency of about 70% to about 100%.

Aspect 18. The method of any one of aspects 1-17, wherein the method results in a carbon yield of about 60% to about 100%.

Aspect 19. The method of any one of aspects 1-18, wherein the method is performed under an inert atmosphere.

Aspect 20. A battery, comprising a carbonaceous material produced by the method of any one of aspects 1-19.

Aspect 21. The battery of aspect 20, wherein an anode of the battery comprises the carbonaceous material.

Aspect 22. The battery of aspect 20 or aspect 21, wherein the battery is a lithium-ion battery or a sodium-ion battery.

From the foregoing, it will be seen that aspects herein are well adapted to attain all the ends and objects hereinabove set forth together with other advantages which are obvious and which are inherent to the structure.

While specific elements and steps are discussed in connection to one another, it is understood that any element and/or steps provided herein is contemplated as being combinable with any other elements and/or steps regardless of explicit provision of the same while still being within the scope provided herein.

It will be understood that certain features and subcombinations are of utility and may be employed without reference to other features and subcombinations. This is contemplated by and is within the scope of the claims.

Since many possible aspects may be made without departing from the scope thereof, it is to be understood that all matter herein set forth or shown in the accompanying drawings and detailed description is to be interpreted as illustrative and not in a limiting sense.

It is also to be understood that the terminology used herein is for the purpose of describing particular aspects only, and is not intended to be limiting. The skilled artisan will recognize many variants and adaptations of the aspects described herein. These variants and adaptations are intended to be included in the teachings of this disclosure and to be encompassed by the claims herein.

Now having described the aspects of the present disclosure, in general, the following Examples describe some additional aspects of the present disclosure. While aspects of the present disclosure are described in connection with the following examples and the corresponding text and figures, there is no intent to limit aspects of the present disclosure to this description. On the contrary, the intent is to cover all alternatives, modifications, and equivalents included within the spirit and scope of the present disclosure.

### D. Examples

The following examples are put forth so as to provide those of ordinary skill in the art with a complete disclosure and description of how the compounds, compositions, articles, devices and/or methods claimed herein are made and evaluated, and are intended to be purely exemplary of the disclosure and are not intended to limit the scope of what the inventors regard as their disclosure. Efforts have been made to ensure accuracy with respect to numbers (e.g., amounts, temperature, etc.), but some errors and deviations should be accounted for. Unless indicated otherwise, parts are parts by weight, temperature is in ° C. or is at ambient temperature, and pressure is at or near atmospheric.

1. Producing Carbonaceous Material from Coal

Disclosed herein is a scalable, microwave-assisted, manufacturing processes to convert coal to hard carbon. The hard carbon can be used as the Na-ion battery (NIB) anode. Compared to conventional thermal pyrolysis, the disclosed microwave heating process microwave offers higher energy efficiency, lower temperature, shorter activation time, and reduced energy requirements. The proposed approach results in higher carbon yield and improved capital utilization due to considerably shorter batch time versus conventional thermal processes. An analysis shows the potential reduction of hard carbon price by 50%. Quality could also be enhanced through the development of a porous structure. Results show that hard carbon produced by the microwave-assisted process has a surface area of ˜50 m²/g, compared to 5-15 m²/g for hard carbons produced via state-of-the-art conventional pyrolysis. Greater surface area results in improved NIB electrochemical performance, for example, in initial sodiation capacity and initial Coulombic efficiency.

Coal samples used can be central and northern Appalachian bituminous, sub-bituminous, and anthracite coal samples. Cleaning (including de-ashing) can be conducted to selectively remove the impurities and produce low-ash coal. Properties such as particle size distribution, ash content, release analysis, and washability can be analyzed and some can be adjusted for the coal sample prior to treatment.

Microwave-assisted manufacturing: Cleaned coal can undergo microwave pyrolysis at temperatures of 800-1000° C. Parameters such as particle size, reaction temperature, time, and ramping rate on the morphology and structure can be adjusted for the microwave treatment process.

Coin cell assembly & testing: The hard carbon produced can be assembled into coin cells. Electrochemical performance characterization and post-mortem analysis can be conducted. The performance data can be used to guide adjustments in parameters for coal cleaning and microwave-assisted manufacturing.

Overall process optimization and preliminary techno-economic analysis (TEA): A preliminary calculation encompassing 20 parameters yielded a hard carbon price of $15/kg, ˜50% of current prices. Operating parameters of the coal cleaning stage, the design and operation of the microwave-assisted reactor, and the system-level parameters such as mass and heat integration can be adjusted with consideration of the electrochemical performance measures and morphological characteristics of the microwave-produced hard carbon.

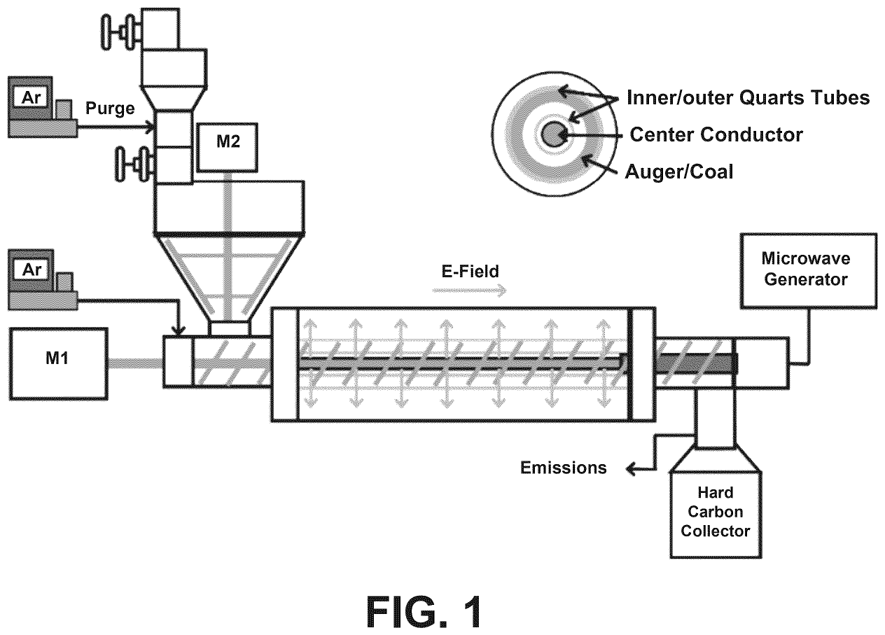

Scale-up of microwave-assisted manufacturing: A microwave reactor can be used for microwave treatment (see, for example, FIG. 1). Coal can be continuously fed into and out of the microwave cavity through mechanical movement and agitation transport. The geometry and size of the inner and outer conductors of the microwave cavity and the auger's morphology will be optimized for efficient coal pyrolysis.

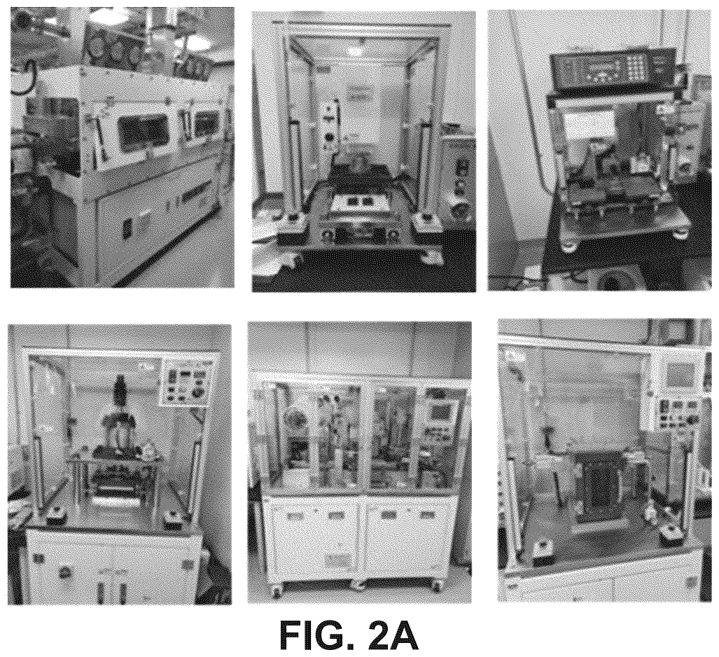

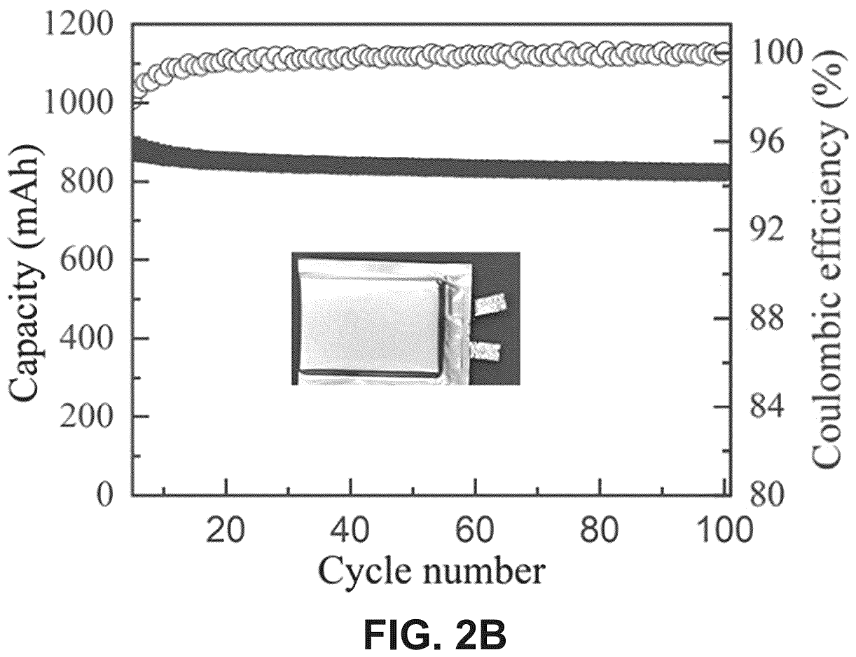

Pouch cell assembly and testing: A pouch cell NIBs can be fabricated and incorporate a hard carbon anode produced at least in part using microwave-assisted methods. Pouch cells can be fabricated using a pouch cell assembly line (such as that depicted in FIG. 2A). Capacity and coulombic efficiency vs cycle number for a representative fabricated ˜1 Ah HC/NaMNC pouch cell is shown in FIG. 2B.

TABLE 1
Example Baseline Method and Product Performance

| | | Benchmark Based on |
|---|---|---|
| | Baseline | Literature Values |
| Surface area (m²/g) | 50 | 5-15 |
| Initial Sodiation capacity (mAh/g) | 270 | 210-290 |
| Initial Coulombic Efficiency | 78% | 69-90% |
| Carbon Yield (%) | 70 | 70 |
| Minimum Selling Price | 19.1 $/kg | 30 $/kg |
| Manufacturing capacity | 2g/day | |

### 2. Additional Data

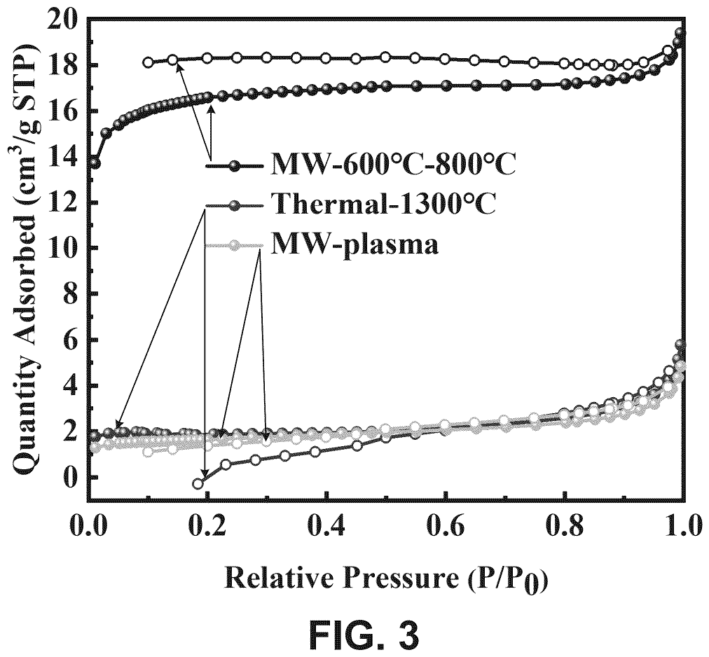

FIG. 3 illustrates the performance of shows a representative plot of carbonaceous material produced from coal using various methods (e.g., microwave-assisted methods and thermal methods). Table 2 provides the properties of a carbonaceous material produced from coal using the various methods, with properties such as the BET surface area (S_{BET}), micropore surface area (S_{micro}), micropore volume (V_{micro}), and mesopore volume (S_{Meso}) of the materials.

TABLE 2
Properties of carbonaceous material produced from coal
using thermal or microwave (MW) treatment methods.

| | S_{BET} | S_{micro} | V_{micro} | V_{Meso} |
|---|---|---|---|---|
| Treatment Method | (m²/g) | (m²/g) | (cm³/g) | (cm³/g) |
| Thermal (1300° C.) | 5.7772 | 6.5558 | 0.0033 | 0.0065 |
| MW (600-800° C.) | 52.8512 | 41.9406 | 0.0208 | 0.0066 |
| MW (plasma) | 5.4079 | 3.1861 | 0.0016 | 0.0050 |

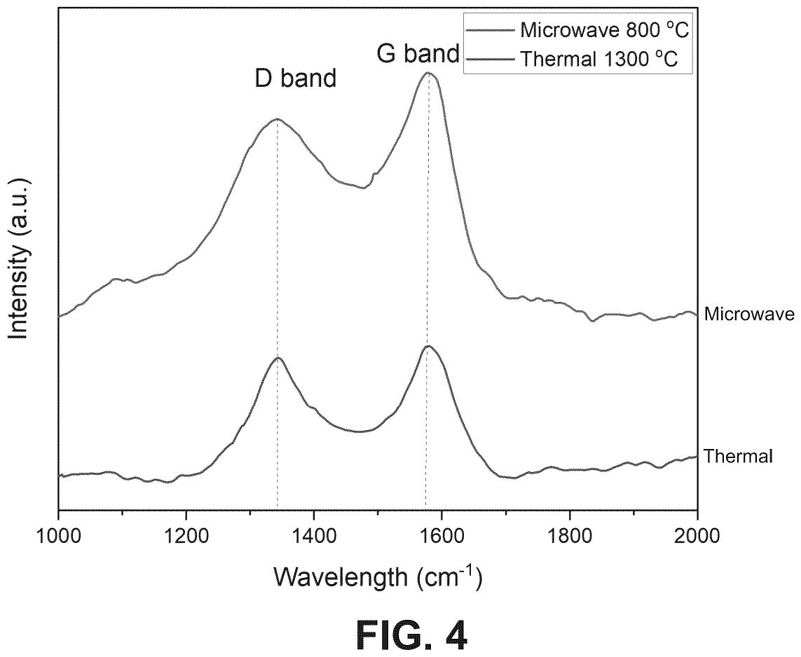

FIG. 4 shows representative Raman spectra characterizations of carbonaceous materials produced from coal using various methods (microwave and thermal). Table 3 provides additional properties of a carbonaceous material produced from coal using the various methods. For thermal and microwave treated samples, the Ip/IG ratios characterized by Raman spectroscopy are 1.05 and 1.38, respectively. This can suggest formation of a more integrated hexacyclic carbon structure in the microwave treated sample with fewer defects compared to the thermally treated sample.

TABLE 3
Additional properties of carbonaceous material
produced from coal using thermal or microwave
(MW) treatment methods along with carbon yield.

| | S_{BET} | | |
|---|---|---|---|
| Sample | (m²/g) | I_{D}/I_{G} | Carbon Yield |
| Thermal (1300° C.) | 5.8 | 1.047 | 70% |
| MW (800° C.) | 52.8 | 1.378 | 60% |

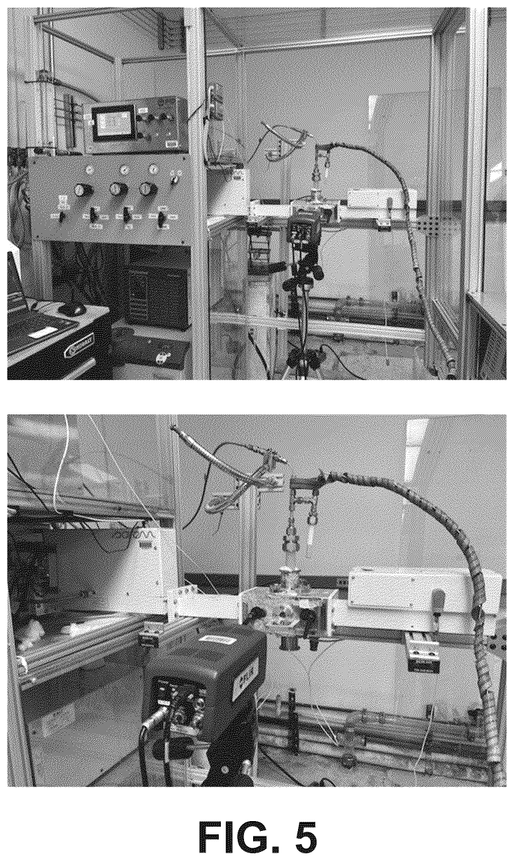

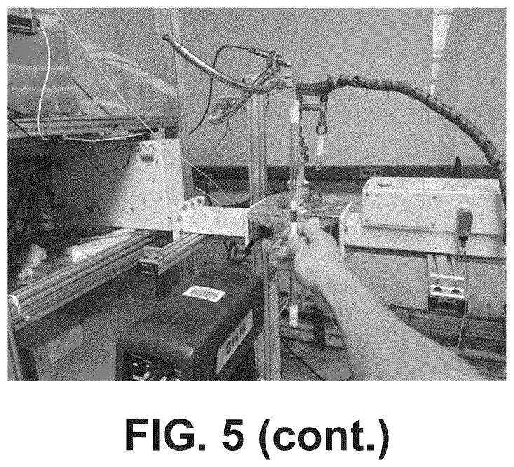

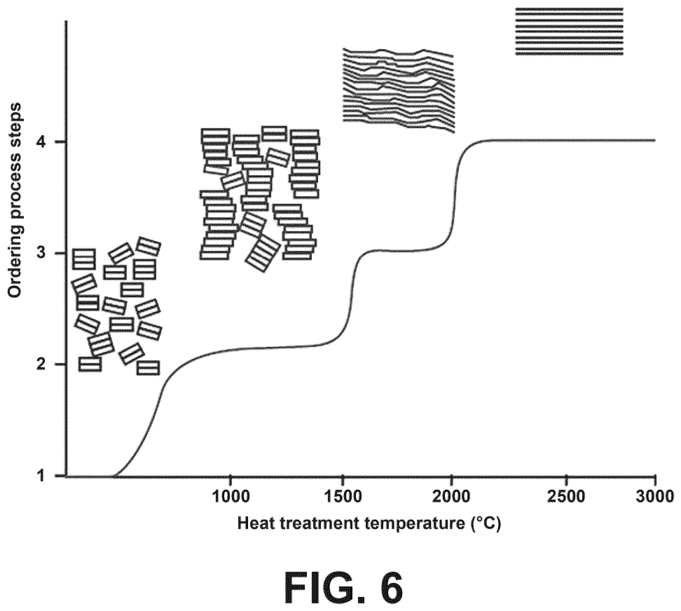

FIG. 5 shows various views of a representative microwave reactor using to produce carbonaceous materials from coal. FIG. 6 demonstrates the change in ordering of a carbon material undergoing heat treatment, with ordering increasing at higher temperatures from hard carbon-like materials on the left of the graph, to soft carbon-like materials around the middle, and to graphite-like carbon materials on the right.

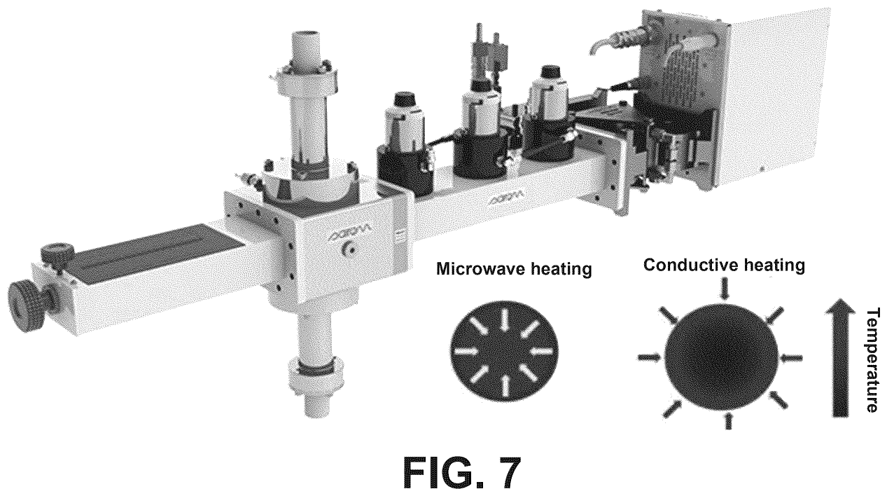

FIG. 7 shows a representative microwave reactor and temperature plots of a reaction chamber heated using microwave heating vs conductive heating in the treatment of coal. As demonstrated, the microwave heating method can treat the coal without subjecting it to the same elevated temperature levels as the conductive heating method.

It will be apparent to those skilled in the art that various modifications and variations can be made in the present disclosure without departing from the scope or spirit of the disclosure. Other aspects of the disclosure will be apparent to those skilled in the art from consideration of the specification and practice of the disclosure disclosed herein. It is intended that the specification and examples be considered as exemplary only, with a true scope and spirit of the disclosure being indicated by the following claims

What is claimed is:

1. A method comprising:
providing a coal material; and
heating the coal material by microwave irradiation or microwave plasma to a target temperature of about 500° C. to about 1200° C., thereby producing a carbonaceous product.

2. The method of claim 1, wherein the target temperature is about 500° C. to about 1000° C.

3. The method of claim 1, wherein the coal material is heated at a rate of about 0.5° C./min to about 50° C./min until reaching the target temperature.

4. The method of claim 1, wherein heating the coal material further comprises holding the coal material at the target temperature for about 30 minutes to about 6 hours.

5. The method of claim 1, wherein the coal material comprises from about 1 wt % to about 15 wt % ash.

6. The method of any claim 1, wherein the coal material comprises anthracite, bituminous coal, subbituminous coal, lignite, or a combination thereof.

7. The method of claim 1, wherein the coal material exhibits an activation time of about 10 minutes to about 90 minutes.

8. The method of claim 1, wherein the carbonaceous product comprises hard carbon, soft carbon, graphitic carbon, or a combination thereof.

9. The method of claim 1, wherein the carbonaceous product has a Brunauer-Emmett-Teller (BET) surface area of about 5 m²/g to about 100 m²/g.

10. The method of claim 1, wherein the carbonaceous product has a micropore surface area of about 5 m²/g to about 90 m²/g.

11. The method of claim 1, wherein the carbonaceous product has a micropore volume of about 0.005 cm³/g to about 0.1 cm³/g.

12. The method of claim 1, wherein the carbonaceous product has an Ip/IG ratio of from about 1.1 to about 1.5, as determined by Raman spectroscopy.

13. The method of claim 1, wherein the carbonaceous product has an Ip/IG ratio of from 1.1 to about 1.5, as determined by Raman spectroscopy.

14. The method of claim 1, wherein the carbonaceous product has an initial sodiation capacity of about 200 mAh/g to about 500 mAh/g.

15. The method of claim 1, wherein the carbonaceous product has an initial coulombic efficiency of about 70% to about 100%.

16. The method of claim 1, wherein the method results in a carbon yield of about 60% to about 100%.

17. The method of claim 1, wherein the method is performed under an inert atmosphere.

18. A battery, comprising a carbonaceous material produced by the method of claim 1.

19. The battery of claim 18, wherein an anode of the battery comprises the carbonaceous material.

20. The battery of claim 18, wherein the battery is a lithium-ion battery or a sodium-ion battery.
